(19) United States
(12) Patent Application Publication
(10) Pub. No.: US 2016/0178286 A1
(43) Pub. Date: Jun. 23, 2016

(54) Heat Transfer Profile

(71) Applicant: LUMITAR ARRAY LIGHTING TECHNOLOGY FINLAND LTD, Vaasa (FI)

(72) Inventor: Igor Piarkiev, Vaasa (FI)

(21) Appl. No.: 14/902,630

(22) PCT Filed: Jul. 2, 2014
(86) PCT No.: PCT/FI2014/050548

§ 371 Date: Jan. 4, 2016

(30) Foreign Application Priority Data
Jul. 4, 2013 (FI) 20135734

(51) Int. Cl. F28F 1/22; F21V 29/74; F28F 1/18

(52) U.S. Cl. CPC F28F 1/22; F28F 1/18; F21V 29/745

(57) ABSTRACT

A heat transfer profile has coaxial cylindrical inner and outer peripheries. A cylindrical first space is formed inside the inner periphery. The cylindrical outer periphery has a shape cut on at least one side. Blade-like heat transfer flanges extend between and contact both the inner periphery and the outer periphery. A second space is provided inside the cut part of the outer periphery, defined in part by a section of the inner periphery and two heat transfer flanges. The second space is open at least from the cut side of the outer periphery to the exterior of the outer periphery.

### BACKGROUND

The invention relates to heat transfer profiles.

Besides energy forms corresponding to their actual purpose, electric devices and components in particular produce losses, mainly heat losses. In addition to being wasted energy, this heat may be harmful to the operation of the device or component in question, or that of another device, component or structure arranged in the vicinity thereof. Indeed, excessive heating may for instance shorten the life of devices, components and structures, decrease their efficiency, or even prevent them from operating appropriately. For example in connection with electronics, lighting and buildings, it is thus often necessary to arrange some cooling so as to transfer heat away from an object heating up.

Heat transfer profiles to be used for heat transfer, such as so-called cooling profiles, are structures designed for optimizing heat transfer from a component, structure or the like producing heat. Such optimization of heat transfer may comprise for instance optimizing the direction, velocity or evenness of the transfer of heat. The heat transfer profiles may be used for cooling or heating, on their own or together with other devices, such as cooling devices, or in connection therewith. Typically, heat transfer takes place particularly through convection and radiation, so the surface area plays an important role, which is why the heat transfer profiles often comprise for instance various plates or spikes for increasing the heat-transferring surface area.

However, for instance cooling profiles are often large in relation to the object to be cooled and, when used in combination with for instance various fans or blowers, they may cause additional air resistance and thus even prevent the cooling air from moving.

### BRIEF DESCRIPTION

An object of the invention is thus to provide a novel heat transfer profile. The object is achieved by a heat transfer profile which is characterized by what is stated in the independent claims. Preferred embodiments of the invention are disclosed in the dependent claims.

The solution is based on forming the heat transfer profile from two peripheries which are arranged inside one another such that an outer one of the peripheries is cut at least over a portion of the length of the periphery and which, within the uniform area of the outer periphery, are connected by heat transfer flanges.

An advantage of the heat transfer profile according to the solution is that it is thus possible to form an as small and light as possible heat transfer structure which transfers heat optimally and which enables for instance versatile active cooling devices or elements, light sources and/or other electrically driven devices or components and/or arms or other fastening or support structures to be easily connected thereto.

### BRIEF DESCRIPTION OF THE FIGURES

The invention is now described in closer detail in connection with the preferred embodiments and with reference to the accompanying drawings, in which:

FIG. 1 schematically shows a heat transfer profile in a cross direction;

FIG. 2 schematically shows a heat transfer profile in perspective;

FIGS. 3a and 3b schematically show crosswise profiles of a heat transfer profile according to different embodiments;

FIG. 4 schematically shows some shapes of heat transfer flanges;

FIGS. 5a and 5b schematically show, from above and in cross-section, some electronic components in connection with a heat transfer profile;

FIGS. 6a and 6b are schematic and partly cross-sectional side views of an embodiment of a heat transfer profile in a cross direction; and

FIGS. 7a, 7b, and 7c schematically show some heat transfer profile arrangements.

### DETAILED DESCRIPTION

In the figures, like reference numerals identify like or similar elements. When the figure comprises several parts or sections of like structure and/or purpose, for the sake of clarity, only one or some of the mutually identical parts or sections is/are usually indicated by reference numerals. It is clear to one skilled in the art that in different embodiments, the features and/or embodiments disclosed in the figures and the description may also be combined in an appropriate manner.

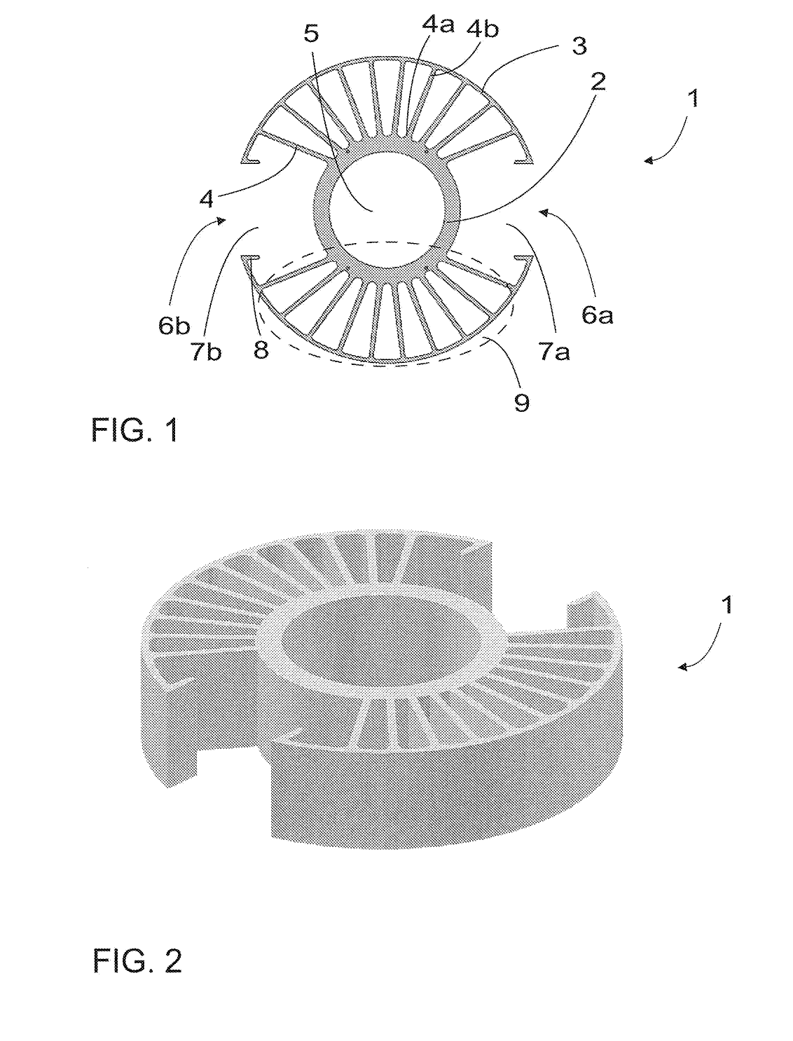

FIG. 1 schematically shows an embodiment of a heat transfer profile 1 as viewed from an end of the cylindrical structure, i.e. in a cross direction. FIG. 2 schematically shows a heat transfer profile 1 in perspective. Such a heat transfer profile may preferably be used for transferring heat away from a heat-producing device or component, such as a light source, electronic component or another corresponding structure electrically driven or otherwise causing heat loss.

The heat transfer profile 1 may comprise a cylindrical uniform inner periphery 2 inside of which a cylindrical first space 5 is formed. The heat transfer profile 1 may further comprise a cylindrical outer periphery 3 arranged outside the cylindrical inner periphery. The outer periphery 3 is preferably arranged coaxially with the inner periphery 2. Preferably, the outer periphery then forms a box-like frame structure around the heat transfer profile. The cylindrical outer periphery 3 may have been formed to have a shape wherein at least one of its sides is cut, in which case the outer periphery 3 comprises at least one discontinuity point 6a, 6b. In the embodiment of FIG. 1, the outer periphery 3 of the heat transfer profile 1 comprises two such discontinuity points 6a, 6b. Depending on the use application, the discontinuity point may differ in size in different embodiments.

The heat transfer profile 1 may further comprise a plurality of blade-like heat transfer flanges 4 extending between the inner periphery 2 and the outer periphery 3, only one such flange being indicated by a reference numeral in FIG. 1. The heat transfer flanges 4 may then join at their first end 4a to the inner periphery 2, and at their second end 4b, which is opposite to the first end, to the outer periphery 3. The number of heat transfer flanges may vary, depending on the use application. Preferably, the heat transfer flanges 4 are in contact with both the inner periphery 2 and the outer periphery 3, at least in an operating position of the heat transfer profile. Particularly preferably, the heat transfer profile 1 comprises heat transfer flanges only within the area of the uniform part of the outer periphery 3. In other words, the heat transfer flanges 4 do not extend to the area of the discontinuity point 6a, 6b of the outer periphery 3 but at the discontinuity point(s) 6a, 6b of the outer periphery 3 the heat transfer flanges 4 reside at a distance from one another which is greater than that within the uniform area of the outer periphery 3.

An advantage of such a structure is that the cylindrical inner periphery 2 evens out differences in heat transfer between different parts of the heat transfer profile. It also saves the surface area required by the heat transfer profile as compared with a planar bottom plate without decreasing the actual heat transfer or cooling surface area. Further, the inner periphery 2 forms a protective periphery between the object to be cooled and, on the other hand, the environment external thereto, enabling the different parts of the structure to be simply and tightly protected from one another and, on the other hand, for instance against environmental influences, such as air, water and impurities, by employing simple seal and cover solutions, for instance.

A further advantage of such a structure is that the outer periphery 3 connects the heat transfer flanges 4, which makes the structure particularly robust and enhances steady heat transfer. In addition, the structure protects the ends of the heat transfer flanges for instance against damage, forming an open, independent box body. In such a case, the outer periphery 3 also serves as an extension of the heat transfer flanges 4, increasing their surface area and thus enabling a structure as compact as possible with respect to the required cooling power.

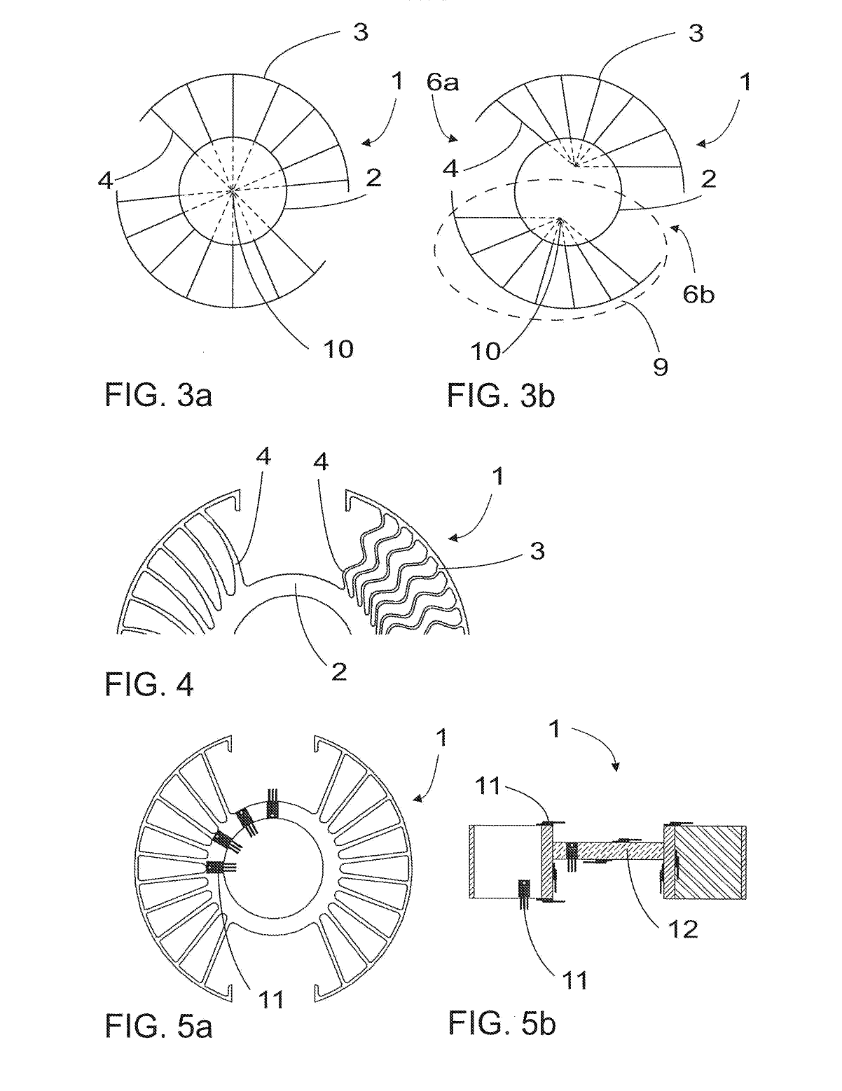

In an embodiment, at least one heat transfer flange 4 is arranged substantially at an angle to at least one other heat transfer flange when viewed from a cross direction. The cross direction refers to a cutting direction perpendicular to the direction of a longitudinal axis of the cylindrical inner periphery 2. In an embodiment, the heat transfer flanges 4 may be arranged between the inner periphery 2 and the outer periphery 3 substantially radially. FIG. 3a schematically shows such a crosswise profile of a heat transfer profile 1. In FIG. 3a, the centre of imaginary continua, i.e. the directional centre 10, of the heat transfer flanges 4 is the centre of the inner periphery 2 and the outer periphery 3. FIG. 3b schematically shows a crosswise profile of a heat transfer profile 1 according to another embodiment. In such a case, the heat transfer flanges 4 may be arranged such that the heat transfer flanges 4 arranged between two discontinuity points 6a, 6b of the outer periphery 3 form a heat transfer flange group 9 (shown in broken line in the figure) wherein the heat transfer flanges 4 are directed from the same direction centre 10, which is different from the centre of the inner periphery 3, towards the outer periphery 3.

FIG. 4 schematically shows some shapes of the heat transfer flanges. One or more heat transfer flanges 4 of the heat transfer profile 1 may thus comprise one or more curved parts. In the cross direction, a first and/or second side of the profile of the heat transfer flange 4 may thus comprise at least one curved part. In an embodiment, in the cross direction at least one side of the profile of the heat transfer flange 4 may comprise at least two curved parts which differ from one another with respect to the direction of the curve and/or the radius of curvature of the curve. In still another embodiment, in the cross direction the profile of the heat transfer flange 4 is substantially straight, as in the embodiments shown in FIGS. 1 to 3b. In such a case, the first side and the second side may be mutually substantially parallel. In an embodiment, all heat transfer flanges 4 of the heat transfer profile 1 are mutually substantially the same in shape. In another embodiment, the heat transfer profile 1 may comprise at least two heat transfer flanges 4 that are mutually different in shape.

It is clear that FIGS. 3a, 3b, and 4 show only some examples of the shape and arrangement of the heat transfer flanges of the heat transfer profile 1. The shape, number and/or arrangement of the heat transfer flanges 4 may thus vary in different embodiments.

When the outer periphery 3 comprises at least one discontinuity point 6a, 6b, a second space 7a, 7b is formed which is defined at least by a section of the inner periphery 2 and two heat transfer flanges 4 and which is open at least from the cut side of the outer periphery 3 to the exterior of the outer periphery 3.

In an embodiment, the outer periphery 3 of the heat transfer profile 1 is cut at least on two sides, i.e. it comprises at least two discontinuity points 6a, 6b. In such a case, inside each cut part, i.e. discontinuity points 6a, 6b, of the outer periphery 3, a second space 7a, 7b, two such second spaces in the embodiment of FIG. 1, is formed which is defined at least by a section of the inner periphery 2 and two heat transfer flanges 4 and which is open at least from the cut side of the outer periphery 3 to the exterior of the outer periphery 3.

In an embodiment, the cut sides, i.e. the discontinuity points 6a, 6b, of the outer periphery are arranged with respect to one another on substantially opposite sides of the outer periphery 3, i.e. opposite to one another on opposite sides of the longitudinal axis of the heat transfer profile 1.

The first space 5 and one or more second spaces 7a, 7b form chamber-like spaces, in the embodiment of FIG. 1 three chamber-like spaces 5, 7a, 7b. These first and second spaces as well as the above-disclosed arrangement thereof enable various fastening and/or support structures, such as arms or supports, as well as for instance active cooling devices, such as blowers, fans and/or cooling elements, to be arranged in the heat transfer profile 1. Such a solution is particularly advantageous because the cooling elements may be arranged in the direction of all three main axes (x, y, z). Some such solutions are shown in FIGS. 5a and 5b, in FIG. 5a from above, i.e. shown in the cross direction of the heat transfer profile, and in FIG. 5b as a cross-sectional side view. In the figures, electric or electronic components 11, such as cooling elements, are depicted with schematic symbols. In different embodiments, the electronic components 11 may comprise for instance light producing or other electric or electronic components, depending on the purpose of use.

In an embodiment, the heat transfer flanges 4 are arranged in a position substantially perpendicular to a cross direction of the cylindrical inner periphery 2 and outer periphery 3. The cross direction of the inner periphery 2 and the outer periphery 3 refers to a cutting direction perpendicular to the longitudinal direction of the heat transfer profile 1, i.e. perpendicular to the direction of the longitudinal axis of the cylindrical inner periphery 2. In other words, the heat transfer flanges 4 extend in a direction substantially parallel with the longitudinal direction of the cylindrical peripheries formed by the inner periphery 2 and the outer periphery 3. In such a case, the heat transfer flanges 4 join at their first end 4a to the inner periphery 2, and at their second end 4b, which is opposite to the first end, to the outer periphery 3. In different embodiments, the crosswise profiles of the heat transfer flanges 4 may vary in the manners shown in FIGS. 3a, 3b, and 4, for instance.

In an embodiment, the heat transfer profile is formed as a structure open at the ends of the cylindrical inner periphery and outer periphery.

In an embodiment, the heat transfer profile comprises aluminium or aluminium alloy.

An embodiment comprises a heat transfer profile wherein the inner periphery, the outer periphery, and the heat transfer flanges form a uniform, fixed structure.

In an embodiment, the outer periphery 3 comprises at edges of a cut part, i.e. a discontinuity point 6a, 6b, projections 8 which are perpendicular to the cross direction of the cylindrical outer periphery 3 and which extend towards the inner periphery. In other words, the projections 8 continue from the outer periphery 3 at the edge of the discontinuity point 6a, 6b towards the inner periphery 2, as shown in FIGS. 1 and 2, for instance.

In an embodiment, the heat transfer profile comprises a base plate 12 arranged in the first space 5 and in contact with the inner periphery. This enables the heat transfer to be further improved by transferring heat efficiently also through the base plate to the inner periphery and, therethrough, to the heat transfer flanges and the outer periphery.

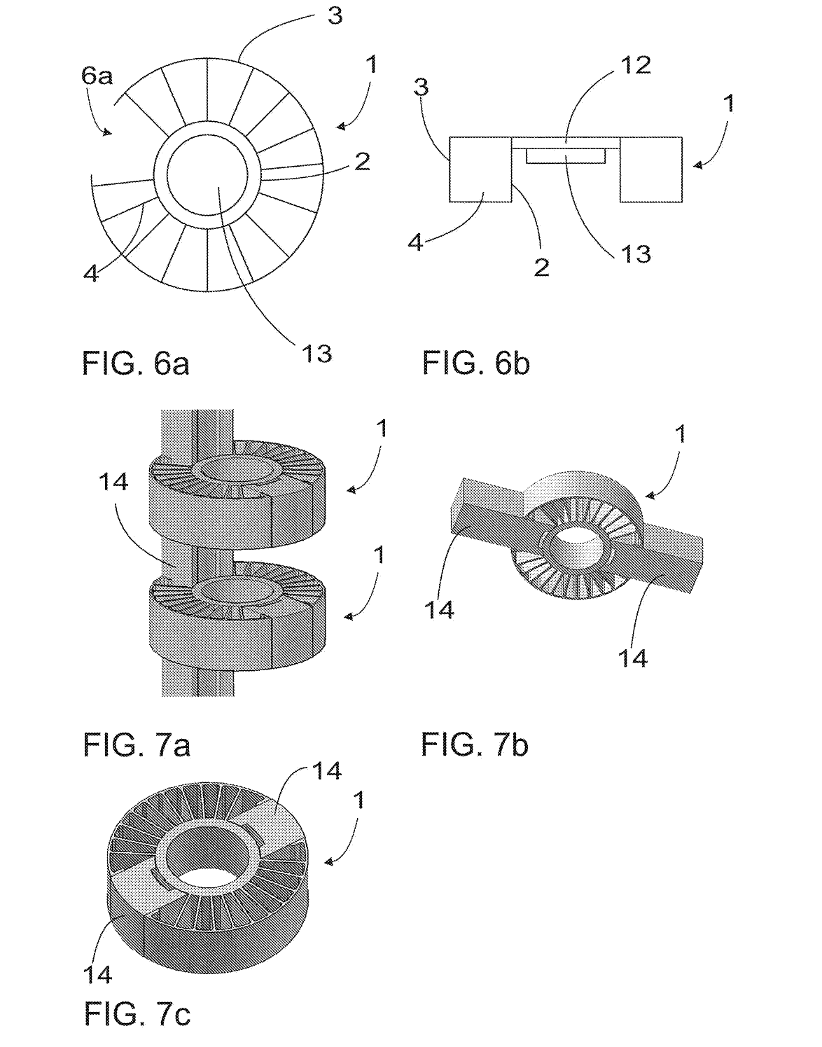

FIGS. 6a and 6b schematically show an embodiment, in FIG. 6a in the cross direction and in FIG. 6b as a partial cross-sectional side view, in which case the heat transfer profile comprises a base plate 12 arranged in the first space 5 and in contact with the inner periphery. In an embodiment, the first space 5 defined by the inner periphery 2 may further be provided with a light source 13 and/or another electric or electronic component 11. FIG. 6a shows an embodiment wherein the outer periphery 3 of the heat transfer profile 1 is provided with only one discontinuity point 6a. In different embodiments, the heat transfer profile 1 and for instance its inner periphery 2, outer periphery 3 and heat transfer flanges 4 may differ from the embodiment of FIG. 6a and may for instance be according to some other embodiment disclosed herein.

An advantage of the present heat transfer profile is that the cooling properties of the heat transfer profile may be influenced by changing the height of the heat transfer profile. This enables modular solutions suitable for different uses and situations, for instance.

In an embodiment, the heat transfer profile may be a cooling profile used for transferring heat away from a heat-producing device or structure in order to optimize the cooling of the device or structure. In another embodiment, the heat transfer profile may be a heating profile used for transferring heat from a heat-producing device or structure in order to optimize the heating of a surrounding structure, space or the like.

In an embodiment, the device structure comprises a heat transfer profile 1 according to any one of the embodiments disclosed above or a combination thereof. The device structure may further comprise at least one of the following: a light source, a transistor, a diode, a resistor, an IC circuit, a fan, a blower, a fastener, and another electronic component.

In an embodiment, the first space 5 of the heat transfer profile may be provided with a light source. The heat transfer profile may further be provided with fastening structures, such as a fastening plate and/or a fastening arm by employing a fastening method known per se, such as screw fastening. In such a case, a lighting structure thus formed and comprising a heat transfer profile may be arrangeable in a ceiling, a wall or a lighting post, for instance. Since an appropriate heat transfer profile enables the optimal operating temperature and thus efficiency of the light source to be ensured also under challenging conditions and the structure can be easily protected by various cover or shield structures, it is simple to produce a structure suitable for street lighting, industrial or warehouse lighting, cold or humid spaces or other demanding conditions, for instance.

An advantage of the above-disclosed solution is that the outer periphery may serve as a substantial part of the frame of the heat transfer profile and/or the device structure and also form a supporting and/or box-like structure around the heat transfer profile and/or the device structure. In such a case, no separate casing is necessarily required at all.

In addition, in embodiments designed for outdoor usage in particular, the disclosed solution, wherein heat transfer flanges are arranged at an angle to one another, enables fouling of the heat transfer profile and particularly clogging of gaps, which weakens the flow of air on the surface of and inside the heat transfer profile, to be diminished considerably as compared with solutions wherein the heat transfer flanges are arranged side by side, mutually parallelly. This may be further improved by arranging the heat transfer flanges farther away from one another taking, however, the heat transfer surface area optimal for the heat transfer demand into consideration. Such a solution is thus highly suited for use in outdoor lighting, for instance, in which case the light source 13 may be arranged in the first space 5 defined by the inner periphery 2, for instance.

FIG. 7a shows yet another heat transfer profile arrangement wherein two heat transfer profiles 1 are arranged in the same bar-like fastening and/or arm structure 14, one after another. In different embodiments, one or more heat transfer profiles may be arranged one after another or one or more heat transfer profile may be arranged in a lamp post, wall and/or ceiling fastener, arm structure or another suitable fastening structure. FIG. 7b shows an embodiment wherein the heat transfer profile 1 is provided with two fastening and/or arm structures 14. Such a heat transfer profile arrangement may be equipped for instance with a light source and fastened to a ceiling, beam structures, wall or another suitable structure in a manner known per se. FIG. 7c shows still another heat transfer profile arrangement, wherein the heat transfer profile 1 is equipped with two fastening and/or arm structures 14 whose outer surface forms a substantially uniform shape together with the heat transfer profile and the outer surface of the outer periphery 3 in particular. Such a heat transfer profile arrangement may be arrangeable for instance in a ceiling or an external fastening arm or another external fastening structure.

It is apparent to a person skilled in the art that as technology advances, the basic idea of the invention may be implemented in many different ways. The invention and its embodiments are thus not restricted to the examples described above but may vary within the scope of the claims.

1. A heat transfer profile for transferring heat, wherein the heat transfer profile comprises:
a cylindrical uniform inner periphery, inside of which a cylindrical first space is formed,
a cylindrical outer periphery which is arranged coaxially outside the cylindrical inner periphery and which has a shape that is cut at least on one side thereof, and
blade-like heat transfer flanges which, only over a uniform part of the outer periphery, extend between the inner periphery and the outer periphery and which are in contact with both the inner and the outer periphery, whereby
inside the cut part of the outer periphery, a second space is formed which is defined at least by a section of the inner periphery and two heat transfer flanges and which is open at least from the cut side of the outer periphery to the exterior of the outer periphery.

2. A heat transfer profile as claimed in claim 1, wherein the outer periphery is cut at least on two sides, whereby inside each cut part of the outer periphery, a second space is formed which is defined at least by a section of the inner periphery and two heat transfer flanges and which is open at least from the cut side of the outer periphery to the exterior of the outer periphery.

3. A heat transfer profile as claimed in claim 2, in which the cut sides of the outer periphery are arranged with respect to one another on substantially opposite sides of the outer periphery.

4. A heat transfer profile as claimed in claim 1, in which the heat transfer flanges are arranged in a position substantially perpendicular to a cross direction of the cylindrical inner periphery and outer periphery.

5. A heat transfer profile as claimed in claim 1, which is formed as a structure open at ends of the cylindrical inner periphery and outer periphery.

6. A heat transfer profile as claimed in claim 1, which comprises aluminium or aluminium alloy.

7. A heat transfer profile as claimed in claim 1, in which the inner periphery, the outer periphery, and the heat transfer flanges form a uniform, fixed structure.

8. A heat transfer profile as claimed in claim 1, wherein the outer periphery comprises, at edges of the cut part, projections which are perpendicular to the cross direction of the cylindrical outer periphery and which extend towards the inner periphery.

9. A heat transfer profile as claimed in claim 1, which comprises a base plate arranged in the first space and in contact with the inner periphery.

10. A device structure comprising a heat transfer profile according to claim 1, and at least one of the following: a light source, an electronic component, a fan, a blower, and a fastener.
